(19) United States
(12) Patent Application Publication
(10) Pub. No.: US 2017/0039493 A1
(43) Pub. Date: Feb. 9, 2017

(54) MANAGING PRODUCT QUALITY THROUGH AN ACHIEVEMENT-BASED WORKFLOW TOOL

(71) Applicant: Blue Sky Studios, Inc., Greenwich, CT (US)

(72) Inventors: Mark McGuire, Pound Ridge, NY (US); Oliver Staeubli, White Plains, NY (US)

(21) Appl. No.: 15/228,256

(22) Filed: Aug. 4, 2016

Related U.S. Application Data
(60) Provisional application No. 62/201,850, filed on Aug. 6, 2015.

(51) Int. Cl. G06Q 10/06; G06Q 30/02

(52) U.S. Cl. CPC G06Q 10/0633; G06Q 30/0201

(57) ABSTRACT

A method, system, and computer program product for executing an achievement-based workflow tool to perform a quality control check of a product are provided. The quality control check includes assigning to each asset of the product an achievement from an achievement type list to produce assigned achievements and executing a set of tests associated with each achievement assigned to each asset of the product. Further, the quality control check includes creating a certificate detailing results of each set of tests and comparing the certificate against the achievement type list to determine which of the assigned achievements been earned by the product.

### CROSS-REFERENCE TO RELATED APPLICATIONS

This patent application claims priority to U.S. Provisional Application No. 62/201,850 filed Aug. 6, 2015, which is incorporated herein by reference in its entirety.

### TECHNICAL FIELD

The present invention is generally related to quality management during product and/or software production. More particularly, example embodiments of the present invention are directed to utilizing an achievement-based workflow tool to manage quality of the three-dimensional animation products.

### BACKGROUND

Conventionally, when producing computer animations, animators must perform complex modeling of physical representations of objects/characters, computer-interpretation of those models, and frame-by-frame rendering of movements of those models to mimic live-action. Thereafter, background features are added to and post-processing is performed on those models to render a sharp, detailed computer animation. The animators that perform these modeling, rendering, and processing operations are generally divided into separate production departments. Each department, in turn, manages and executes these operations in a particular order know as a production pipeline. The production pipeline is generally a serial set of actions where each downstream production department generally relies on a work product of an upstream production department.

Conventional quality control of the work products produced throughout the serial production pipeline is binary. For example, when an upstream department generates a work product, a test is run on that work product. If that work product passes the test then that work product is passed to a downstream department. If that work product fails the test then that work product is not allowed to pass downstream.

Often times, a failed test is only on a particular aspect of a product that may or may not be necessary for all downstream departments. For example, with respect to producing a computer animation, a character work product produced by a character department may be ready for an animation department but not have all necessary settings needed by a lighting department. Using conventional binary quality control on the character work product prevents this ‘work-in-progress’ from proceeding to the animation department because the character work product is not fully complete. In turn, the entire production pipeline is halted affecting a product readiness and resulting in unwanted costs, expenses, and consumption of time. In addition, downstream departments are then frustrated as the conventional binary quality control intrudes on the artistic process. This can lead to the intentionally skipping of steps of the conventional binary quality control by the downstream departments or a complete abandonment of the quality control process altogether. What are needed are new systems and methods that preserve the quality control process without halting the production of a computer animation.

### SUMMARY

Embodiments include a method, system, and computer program product for executing an achievement-based workflow tool to perform a quality control check of a product. The quality control check comprises assigning to each asset of the product an achievement from an achievement type list to produce assigned achievements; executing a set of tests associated with each achievement assigned to each asset of the product; creating a certificate detailing results of each set of tests; and comparing the certificate against the achievement type list to determine which of the assigned achievements been earned by the product.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter that is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a process flow in accordance with an embodiment;

FIG. 2 depicts another process flow in accordance with an embodiment;

FIG. 3 illustrates an interface in accordance with an embodiment;

FIG. 4 illustrates another interface in accordance with an embodiment; and

FIG. 5 depicts a processing system in accordance with an embodiment.

### DETAILED DESCRIPTION

Embodiments described herein to quality management during product and/or software production. More particularly, example embodiments of the present invention are directed to utilizing an achievement-based workflow tool to manage quality of the three-dimensional animation products.

In general, an achievement-based workflow tool (herein “workflow tool”) enables ‘work-in-progress’ products to proceed to downstream departments through achievements. That is, the workflow tool manages the development, deployment, and debugging of pipeline processes that produce intermediary products and final products. The workflow tool can include an integrated development environment (IDE) with visual drag & drop coding and flow control, a system for in-house coding library management integrated, an intuitive debugger and profiler that allows step through processing, a cross-package filtering system to distill large scenes and search for particular product parameters, and a multi-process execution engine that provides real-time and configurable processing feedback. An example application of the workflow tool includes managing production pipelines for computer animations.

The workflow tool can comprise computer readable instructions for performing the creation and modification of products, where the computer readable instructions are executable by a processor and stored on a memory. The workflow tool can operate within a system that includes one or more computers, one or more user computing devices, and/or one or more databases that can communicate via a network (each of which is further described below). The workflow tool is necessarily rooted in this system to perform proactive operations to overcome problems specifically arising in the realm of product quality control (e.g., problems regarding product readiness, resulting in unwanted costs, expenses, and consumption of time).

For example, while conventional binary quality control cause unnecessary production delays, the workflow tool enable ‘work-in-progress’ product to proceed to subsequent departments via achievements. In this way, any ‘work-in-progress’ product that has met particular achievements may be passed between an upstream department to any downstream department that is ready to contribute to the product even if the same product is not ready for other downstream department contributions. With respect to the production of computer animations, a ‘work-in-progress’ character product of a character department can proceed to an animation departments when the ‘work-in-progress’ character product has met particular achievements even if the same ‘work-in-progress’ character product is not ready for the lighting department.

A product is data, a figure, and/or creation from a department, an artist, set of artists, programmer, set of programmers, etc. that can be delivered downstream to a department, a next artist, set of artists, programmer, set of programmers, etc. Products can have multiple iterations or versions as they are passed between departments, such as an original iteration, intermediary iterations, and a final iteration. Products can be in the form of a file format that includes information, such as geometry, maps, painted maps, shading maps, mathematically generated models, animated rigs (e.g., skeletal structure of a three dimensional figure), program code, heuristics, etc. Products can be assigned a list of achievements that are considered “achievable.” Further, when a product is published, a set of tests associated with that product can be run and a certificate detailing the results of those tests is generated.

Achievements or achievement types are a set of markers recorded in a database. Achievements can describe what are the necessary products, can comprise of test code to identify whether those production parameters have been met, can include a list of downstream departments typically interested in these production parameters, and/or can include subjective point values indicating these importance of particular parameters. Examples of an achievement with respect to the production of computer animations include, but are not limited to, an ‘is renderable’ achievement that identifies that a product is ready to be fed to a rendering engine to produce an image, an ‘is animatable’ achievement that identifies that a product has a rig and is ready to be further processed by an animator, a ‘has fur’ achievement that identifies that a product has been outfitted with fur and is ready to be further processed by an animator, an ‘is effects ready’ achievement that identifies that a particular product is ready for a simulation of effects, etc.

A set of tests (or in the singular, a test) is a plurality of benchmarks utilized to determine whether aspects of a product are completed. In this way, the set of tests are utilized by the workflow to confirm if an achievement is earned for that product. For instance, each test can directly correspond to a particular asset such that particular sets of tests can correspond to an achievement that aligns with a set of assets, such that each set of tests can amount to a different achievement. In one example with respect to the production of computer animations, geometry and effects can correspond to at least two tests that align with aspects of a character product. Each of these at least two tests can respectively identify whether there is a uniform surface of the character product. If both tests are passed, then the ‘is renderable’ achievement is earned by the character product and the character product can proceed to rendering.

A certificate, as indicated above, can detail the results of the set of tests. The certificate can be a file, a macro, a data structure, etc. that stores the results of the set of tests. The certificate can be selectable and transferable. The certificate can further include all results for all tests associated with a version of a product. In this way, each version (e.g., immutable instance or iteration) of the product includes a record of passed or failed tests via each corresponding certificate that enables development, deployment, and debugging of the pipeline process.

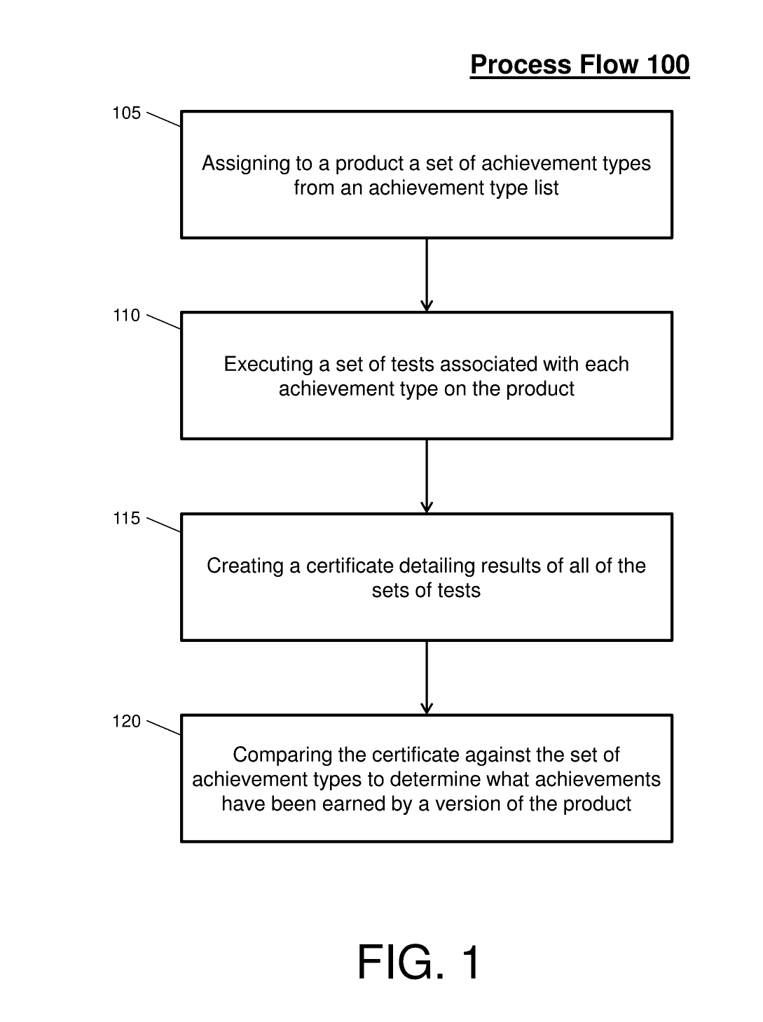

Reference is now made to FIGS. 1-4, which show examples of process flows and interfaces of embodiments of the present invention.

Beginning with FIG. 1, a process flow 100 is depicted in accordance with an embodiment. Process flow 100 starts at block 105, where the workflow tool assigns to a product a set of achievement types from an achievement type list. Then, at block 110, the workflow tool executes a set of tests associated with each achievement type on the product. Each set of tests are configured to determine whether a particular aspect of that product is complete.

Next, at block 115, the workflow tool creates a certificate detailing results of all the sets of tests. Then, at block 120, the workflow compares the certificate against the set of achievement types to determine what achievements have been earned by a version of the product.

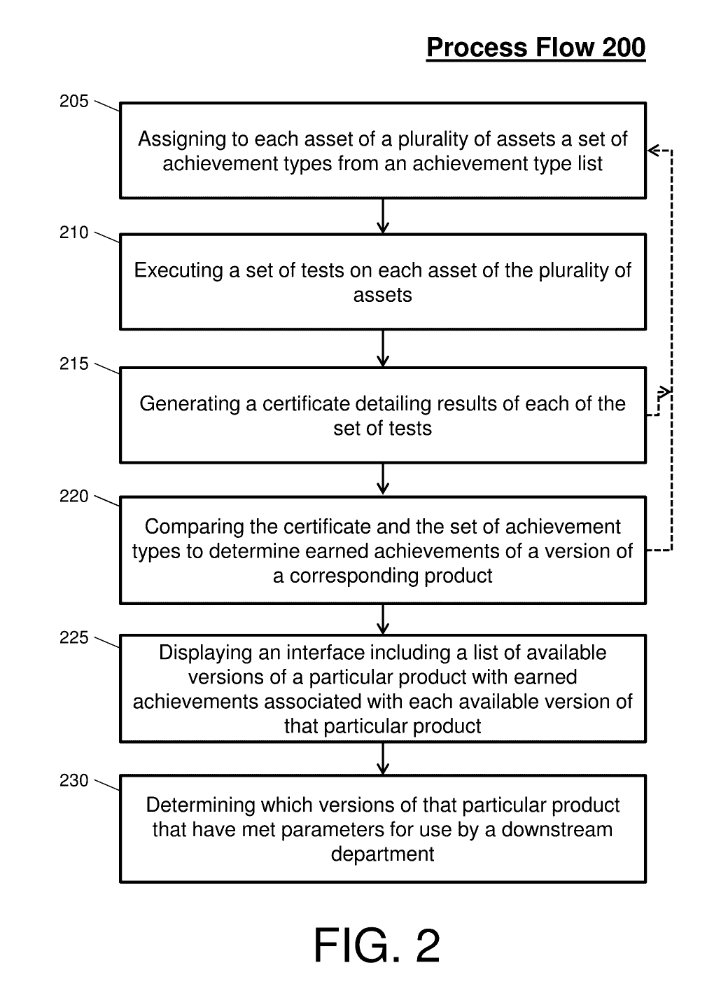

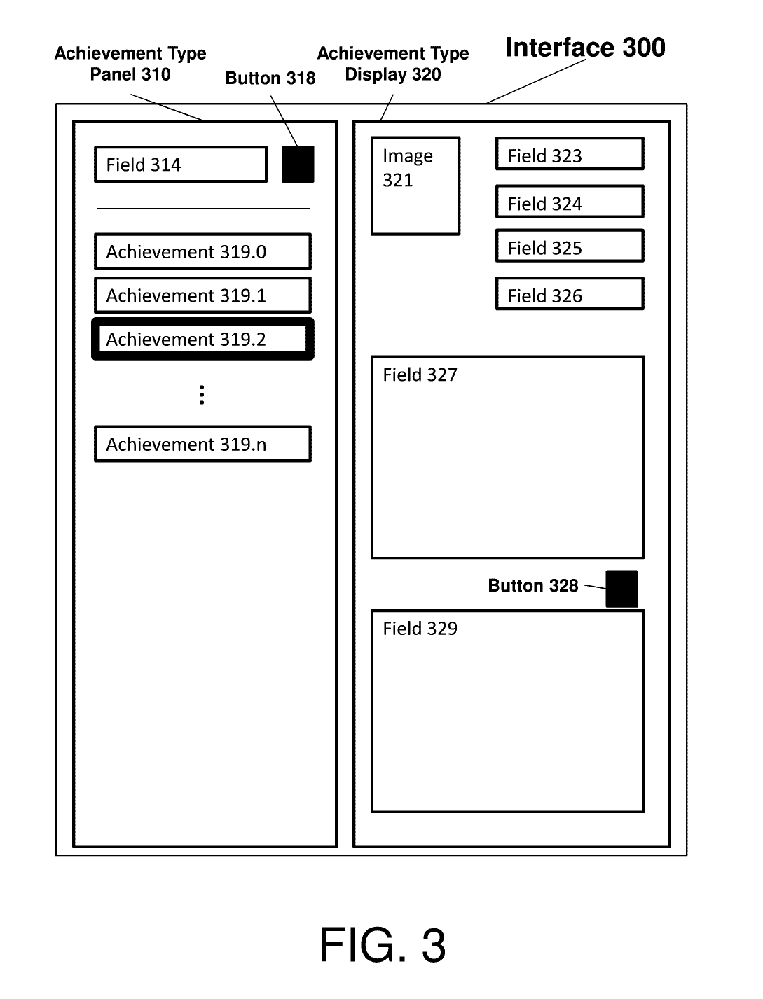

Turning now to FIG. 2, another process flow 200 is depicted in accordance with an embodiment. Process flow 100 starts at block 205, where the workflow tool assigns to each asset of a plurality of assets a set of achievement types from an achievement type list, where the plurality of assets are associated with a first character product of an upstream character department. To create and assign achievement types, the workflow tool can receive and utilize input via an interface (e.g., from a user in the upstream department). For example, FIG. 3 illustrates an interface 300 in accordance with an embodiment.

The interface 300 includes an achievement type panel 310 that further includes a field 314, a button 318, and a plurality of achievements 319 (e.g., list of achievements, such as an achievement 319.0 to an achievement 319.n, where n is an integer greater than 0). The interface 300 also includes an achievement type display 320 that further includes an image 321, fields 323-327, button 328, and field 329. The achievement type display 320 displays the attributes of an achievement selected from the plurality of achievements 319.

Achievements can be subtracted or added to the achievement type panel 310 on an as needed basis. For example, the field 314 can be a text entry field for submitting a name of a new achievement that will be added to the achievement type panel 310. Further, the button 318 can be an add button used to submit the name and create the new achievement.

The image 321, fields 323-327 and 329 are editable/configurable portals corresponding to the attributes of the achievement selected. The image 321 can present an immediately recognizable symbol regarding the importance of the selected achievement (e.g., the symbol can correspond to a bronze, silver, or gold icon; the symbol can correspond to a rank between 1-5 with 1 being the most important). The field 323 can indicate a name of the selected achievement. The field 324 can indicate a shortened name of the selected achievement. The field 325 can indicate a point value regarding the importance of the selected achievement (e.g., an integer between 0-100 with 100 indicating the highest weighted importance). The field 326 can indicate an icon associated with the selected achievement. The field 327 can indicate of a description of the selected achievement.

The field 329 can be an entry field for submitting and displaying a set of tests of the selected achievement. That is, the set of tests displayed by the field 329 represent the measures and procedures that will be executed to determine if the selected achievement is earned. Further, the button 328 can be an add button used to create a new test. As shown in FIG. 3, because the achievement 319.2 is selected (as indicated by the bolded box), the achievement type display 320 and components therein collectively display attributes corresponding to that selected achievement 319.2.

Then, at block 210, the workflow tool executes a set of tests on each asset of the plurality of assets. Next, at block 215, the workflow tool generates and publishes a certificate detailing the results of the set of tests. The certificate directly corresponds to the first character product. Then, at block 220, the workflow compares the certificate and the set of achievement types to determine earned achievements of each version of each corresponding asset of the plurality of products. In addition, the process flow 200 can loop back (as indicated by the dashed arrows) through blocks 205 to 220 to process additional character product versions produced by the upstream character department, thereby accumulating a plurality of certificates that correspond to the plurality of character product versions.

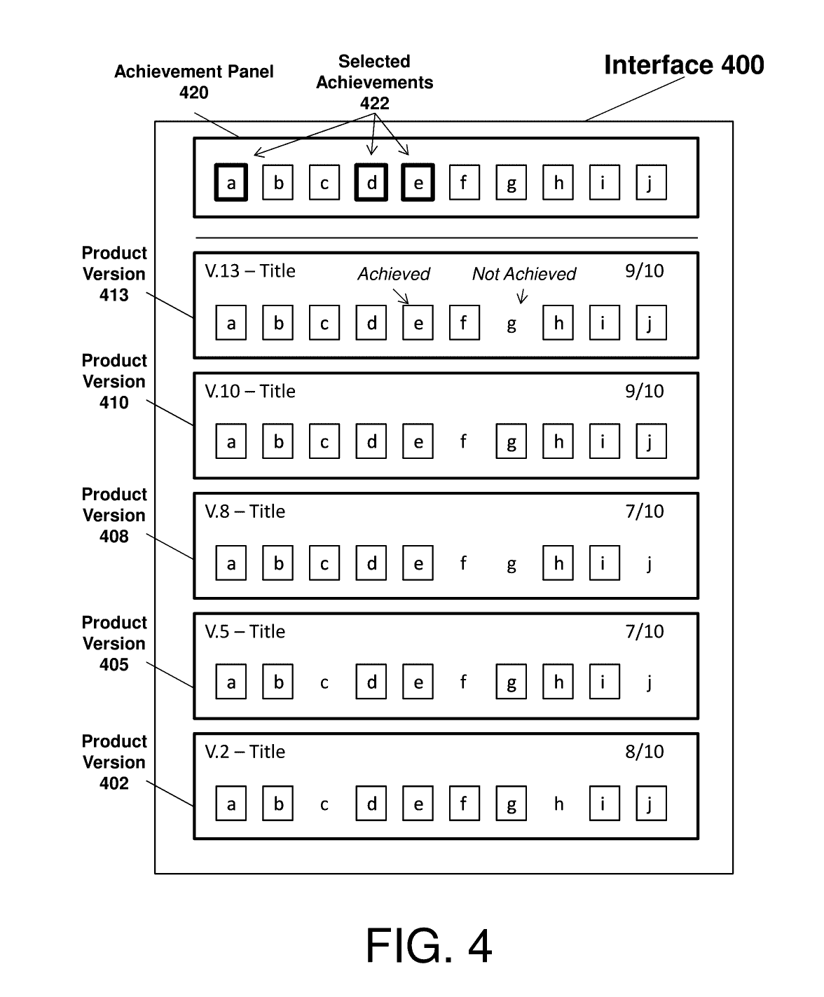

Next, at block 225, the workflow tool displays an interface including a list of available versions of a particular product and the earned achievements of each available version of that particular asset. The list of available versions can correspond to the plurality of character product versions. The earned achievements can be identified via the plurality of certificates. For example, FIG. 4 illustrates an interface 400 in accordance with an embodiment.

The interface 400 includes an achievement panel 420 that displays a list of tiles 422. The list of tiles 422 presented in the achievement panel 420 can vary in number in accordance with the achievements assigned to a selected product. These tiles 422 are selectable to enable the interface to show versions of the selected product that meet the achievements corresponding to the selected tiles 422.

As shown in FIG. 4, the achievement panel 420 presents tiles a-j with tiles a, d, and e selected (as indicated by the bold box). The selection of these tiles acts as a filter. In turn, the product versions shown by the interface 400 are only those product versions that have the achievements associated with tiles a, d, and e completed (note that the transparency of a tile can indicate a status, such as tile e is achieved and tile g is not achieved in product version 413. In this way, the interface 400 presents product versions 402, 405, 408, 410, and 413, which correspond to different immutable instances of the same product. In addition, each selectable tiles 422 can show a rank or importance of the corresponding achievement (e.g., with respect to field 321 and/or field 325 of FIG. 3).

Then, at block 230, the workflow tool determines which versions of that particular product have met parameters for use by a downstream department. With respect to the animation example above, if a downstream animation department requires that achievements associated with tiles a, d, and e be completed, then each product versions 402, 405, 408, 410, and 413 are available to that department. Further, if a downstream lighting department requires that achievements associated with tiles a, d, e, and g be completed, then product versions 402, 405, and 410 are available to that department.

In view of the above, the technical effects and benefits of embodiments herein include a certificate that can be then matched up against a list of what achievements are actually achievable to determine what achievements have been earned by a corresponding version of a product. Further, the technical effects and benefits of embodiments herein include a list of available versions of a particular product, along with achievements that have been earned by that specific version, through an achievement version interface that a downstream department/user can view. Therefore, embodiments herein enable artists to easily identify which versions of a product have met the necessary parameters for use by that department/user. Further, the technical effects and benefits of embodiments herein include assignment of a point value to incentivize upstream departments/users to create the highest quality version of a product before outputting. Point values also provide an indicator to a department/user if a new version of a product has a regression.

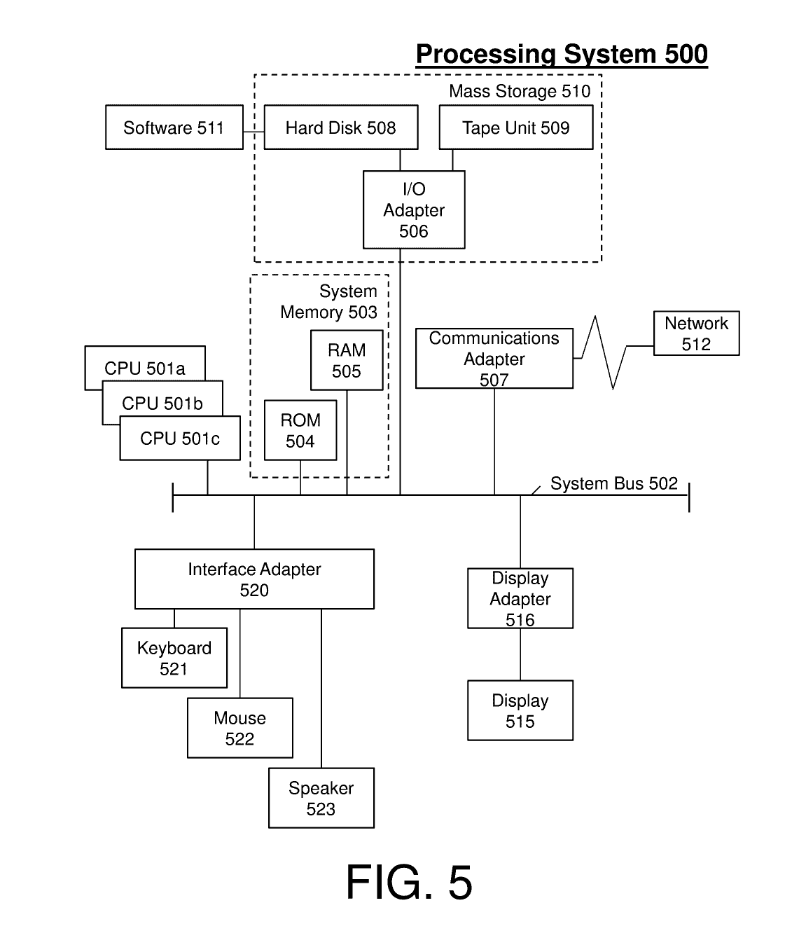

A computer system or an apparatus herein may implement embodiments. For example, FIG. 5 illustrates a processing system 500 as a computer apparatus, according to an embodiment. In this embodiment, the processing system 500 has one or more central processing units (processors) 501a, 501b, 501c, etc. (collectively or generically referred to as processor(s) 501). Therefore, portions or the entirety of the methodologies described herein may be executed as instructions in the processor 501 of the processing system 500. The processors 501, also referred to as processing circuits, are coupled via a system bus 502 to system memory 503 and various other components. The system memory 503 can include read only memory (ROM) 504 and random access memory (RAM) 505. The ROM 504 is coupled to system bus 502 and may include a basic input/output system (BIOS), which controls certain basic operations of the processing system 500. RAM is read-write memory coupled to system bus 502 for use by processors 501.The system memory 503 can be utilized for storage of instructions and information

FIG. 500 further depicts an input/output (I/O) adapter 506 and a communications adapter 507 coupled to the system bus 502. I/O adapter 506 may be a small computer system interface (SCSI) adapter that communicates with a hard disk 508 and/or tape storage drive 509 or any other similar component. I/O adapter 506, hard disk 508, and tape storage drive 509 are collectively referred to herein as mass storage 510. Software 511 for execution on processing system 500 may be stored in mass storage 510. The mass storage 510 is an example of a tangible storage medium readable by the processors 501, where the software 511 is stored as instructions for execution by the processors 501 to perform a method, such as the process flows of FIGS. 1-2. Communications adapter 507 interconnects system bus 502 with an outside network 512 enabling processing system 500 to communicate with other such systems. A screen 515 (e.g., a display monitor) can be connected to system bus 502 by display adapter 516, which may include a graphics controller to improve the performance of graphics intensive applications and a video controller. In one embodiment, adapters 506, 507, and 516 may be connected to one or more I/O buses that are connected to system bus 502 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 502 via an interface adapter 520 and the display adapter 516. A keyboard 521, mouse 522, and speaker 523 can be interconnected to system bus 502 via interface adapter 520, which may include, for example, a Super I/O chip integrating multiple device adapters into a single integrated circuit.

Thus, as configured in FIG. 5, processing system 505 includes processing capability in the form of processors 501, and, storage capability including system memory 503 and mass storage 510, input means such as keyboard 521 and mouse 522, and output capability including speaker 523 and display 515. In one embodiment, a portion of system memory 503 and mass storage 510 collectively store an operating system to coordinate the operations of the various components shown in FIG. 5.

Another embodiment may be implemented, in software, for example, as any suitable computer program on a computer system somewhat similar to the processing system 500. For example, a program in accordance with the present invention may be a computer program product causing a computer to execute the example methods described herein.

Another embodiment may be a system incorporating some or all of the above can include a computer apparatus, a means for display in communication with the computer apparatus, and/or a means for storage in communication with the computer apparatus.

The computer apparatus may be any suitable computer apparatus including a server system, multi-processor system, personal computer, networked computing cluster, computing cloud, or any computer apparatus capable of practicing example embodiments.

The means for display may be any suitable display, including a passive, active, or auto-stereoscopic 3D display (e.g., 3D-LCD, 3D-Plasma, 3D-computer monitor, lenticular screened display, parallax barrier screened display) or a conventional display (e.g., computer monitor, LCD, plasma, etc.).

The means for storage (e.g., mass storage 510 and/or system memory 503) may be any suitable storage means disposed to store information related to 3D animation. The storage means may include a single storage element, or a plurality of storage elements. The storage means may be used in combination with any storage available on the computer apparatus, or may be omitted if suitable storage is available on the computer apparatus. The storage means may include backup elements and/or recording elements. The recording elements may be disposed and configured to produce usable copies of any 3D animation produced at the computer apparatus. The usable copies are copies of a 3D animation which are viewable at a suitable apparatus. For example, a suitable apparatus may include a means for reading 3D animation data from a copy (DVD, double-reel film, recording media, etc). The suitable apparatus may also include means for displaying stereoscopic images/frames read from the 3D animation data. The displaying may include displaying left/right frames in parallel, successively, superimposed, or in any suitable fashion.

According to yet another example embodiment, a computer program product can include a tangible storage medium readable by a computer processor and storing instructions thereon that, when executed by the computer processor, direct the computer processor to perform a method in accordance with some or all of the above. Example may include a computer program product on a computer usable medium with computer program code logic containing instructions according to the FIGS. 1-2 embodied in tangible media as an article of manufacture. Articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the embodiments described herein. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the embodiments described herein. When implemented on a general-purpose microprocessor, the computer program code logic segments configure the microprocessor to create specific logic circuits.

The computer-readable storage medium may be a built-in medium installed inside a computer main body or removable medium arranged so that it can be separated from the computer main body.

Further, such programs, when recorded on computer-readable storage media, may be readily stored and distributed. The storage medium, as it is read by a computer, may enable the method(s) disclosed herein, in accordance with an embodiment.

According to yet another example embodiment, the workflow tool can interface with a code distribution system to give developers access to a growing library of tasks. Tasks can be programmatic constructs and iterators (e.g. if/elif/else, while, foreach), package specific templates (e.g. MayaTask, HoudiniTask, NukeTask), UI constructors (e.g. Slide) as well as generic system executions. Developers can subclass tasks within the workflow tool to create custom workflow tasks (e.g. QMayaTask) all using any code syntax (e.g., Python 00). The workflow tool, in turn, can provide developers access to two sets of data storage objects during execution: Configuration Data (CFG) and Run Time Data (RTD). CFG data is used to set defaults to the code and provide overrides via user interface input. CFG data is immutable during execution. RTD data allows developers to pass calculated results throughout the execution process. Serializing these data objects while providing access to both local and farm machines for RTD modification presented challenges for locking and integrity. With respect to Python OO, due to Python's threading limitations, the workflow tool implements multiprocessing through separate processes rather than threads and facilitates inter-process communication through network sockets. In this way, the workflow tool has the benefits of not being limited by the threading capabilities of potential host applications (e.g., the members of the processing tree can be distributed among several host machines).

Further, the workflow tool can manage the initialization and communication with its worker instances leaving developers free to concentrate on the high level workflow. The workflow tool also embodies further usability by standardizing debugging and logging and by controlling the execution of the Python code, which allows developers to step through any corresponding execution graphs. This execution can be recorded with the profiler to pinpoint inefficiencies in the code or workflows. The workflow tool can also avoid pre-computing an execution graph because the workflow tool can dynamically alter the execution graph during the execution. The workflow tool, in turn, includes the ability to suspend execution to allow user input. For example, a workflow tool package can be executed until it reaches a certain point, save its state, and be continued at a later time, which is particularly useful for long running workflows that include human approval before continuing through a graph. Also, the workflow tool allows developers to customize notifications at the task or task type level to distinguish between data integrity issues (e.g., notify an upstream artist) or code execution errors (e.g., notify a production engineer).

According to yet another example embodiment, the workflow tool can focus purely on the development and deployment of pipeline code written in Python. Because of its pure Python implementation, the workflow tool can avoid competing in the processing space of execution engines by sitting above these engines. Further, the workflow tool can include a text editor that can be used in place of or in addition to other dedicated IDEs (e.g., such as Eclipse or Sublime). The workflow tool can also compliment third party tools with Python interpreters by allowing development and debugging packages of code that can be re-used within other applications. Thus, the workflow tool can execute across packages while using playback and debugging tools.

Therefore, the methodologies and systems of example embodiments can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: a discrete logic circuit(s) having logic gates for implementing logic operations upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical operations or steps in the process, and alternate implementations are included within the scope of at least one example embodiment in which operations may be executed out of order from that shown or discussed, including substantially concurrently or in reverse order, depending on the operability involved, as would be understood by those reasonably skilled in the art.

Any program which would implement operations or acts noted in the figures, which comprise an ordered listing of executable instructions for implementing logical operations, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the embodiments herein includes embodying the operability of the preferred embodiments in logic embodied in hardware or software-configured mediums.

It should be emphasized that the above-described embodiments, particularly, any detailed discussion of particular examples, are merely possible examples of implementations, and are set forth for a clear understanding of the principles of the invention. Many variations and modifications may be made to the above-described embodiment(s) without departing substantially from the spirit and principles of the invention. All such modifications and variations are intended to be included herein within the scope of this disclosure and protected by the following claims.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof Therefore, the terminology used herein is for the purpose of describing particular embodiments only and is not intended to be limiting of example embodiments.

It should also be noted that in some alternative implementations, the operations/acts noted may occur out of the order noted in the FIGS. For example, two figures shown in succession may in fact be executed substantially concurrently or may sometimes be executed in the reverse order, depending upon the operability/acts involved.

1. A method for executing an achievement-based workflow tool to perform a quality control check of a product, comprising:
assigning, by a processor coupled to a memory, to each asset of the product an achievement from an achievement type list to produce assigned achievements;
executing, by the processor, a set of tests associated with each achievement assigned to each asset of the product;
creating, by the processor, a certificate detailing results of each set of tests; and
comparing, by the processor, the certificate against the achievement type list to determine which of the assigned achievements been earned by the product.

2. The method in accordance with claim 1, further comprising:
presenting an interface comprising the product and the achievements that have been determined as earned.

3. The method in accordance with claim 1, further comprising:
determining that the product is ready for a downstream department when all of the assigned achievements have been earned.

4. The method in accordance with claim 1, further comprising:
populating the achievement type list via an interface by creating production parameters with respect to the asset of the product.

5. The method in accordance with claim 1, wherein the product is one of a plurality of product versions, each product version receiving the quality control check.

6. The method in accordance with claim 1, wherein the set of tests are a plurality of benchmarks utilized to determine whether the aspects of the product are completed.

7. The method in accordance with claim 1, wherein the product is an animation product produced from a computer animation production pipeline.

8. A system for executing an achievement-based workflow tool to perform a quality control check of a product, comprising:
a memory having computer readable instructions regarding the achievement-based workflow tool; and
a processor for executing the computer readable instructions, the computer readable instructions comprising:
assigning to each asset of the product an achievement from an achievement type list to produce assigned achievements;
executing a set of tests associated with each achievement assigned to each asset of the product;
creating a certificate detailing results of each set of tests; and
comparing the certificate against the achievement type list to determine which of the assigned achievements been earned by the product.

9. The system in accordance with claim 8, the computer readable instructions comprising:
presenting an interface comprising the product and the achievements that have been determined as earned.

10. The system in accordance with claim 8, the computer readable instructions comprising:
determining that the product is ready for a downstream department when all of the assigned achievements have been earned.

11. The system in accordance with claim 8, the computer readable instructions comprising:
populating the achievement type list via an interface by creating production parameters with respect to the asset of the product.

12. The system in accordance with claim 8, wherein the product is one of a plurality of product versions, each product version receiving the quality control check.

13. The system in accordance with claim 8, wherein the set of tests are a plurality of benchmarks utilized to determine whether the aspects of the product are completed.

14. The system in accordance with claim 8, wherein the product is an animation product produced from a computer animation production pipeline.

15. A computer program product for executing an achievement-based workflow tool to perform a quality control check of a product, the computer program product comprising a computer readable storage medium having program instructions regarding the achievement-based workflow tool embodied therewith, the program instructions executable by a processor to cause the processor to perform:
assigning to each asset of the product an achievement from an achievement type list to produce assigned achievements;
executing a set of tests associated with each achievement assigned to each asset of the product;
creating a certificate detailing results of each set of tests; and
comparing the certificate against the achievement type list to determine which of the assigned achievements been earned by the product.

16. The computer program product in accordance with claim 15, the program instructions executable by a processor to cause the processor to perform:
presenting an interface comprising the product and the achievements that have been determined as earned.

17. The computer program product in accordance with claim 15, the program instructions executable by a processor to cause the processor to perform:
determining that the product is ready for a downstream department when all of the assigned achievements have been earned.

18. The computer program product in accordance with claim 15, the program instructions executable by a processor to cause the processor to perform:
populating the achievement type list via an interface by creating production parameters with respect to the asset of the product.

19. The computer program product in accordance with claim 15, wherein the product is one of a plurality of product versions, each product version receiving the quality control check.

20. The computer program product in accordance with claim 15, wherein the product is an animation product produced from a computer animation production pipeline.
